(19) United States
(12) Patent Application Publication
(10) Pub. No.: US 2016/0013488 A1
(43) Pub. Date: Jan. 14, 2016

(54) POWER STORAGE ELEMENT

(71) Applicants: Hisamitsu KAMEZAKI, Kanagawa (JP); Nobuaki ONAGI, Kanagawa (JP); Masaki YOSHIO, Saga (JP)

(72) Inventors: Hisamitsu KAMEZAKI, Kanagawa (JP); Nobuaki ONAGI, Kanagawa (JP); Masaki YOSHIO, Saga (JP)

(21) Appl. No.: 14/794,994

(22) Filed: Jul. 9, 2015

(30) Foreign Application Priority Data
Jul. 14, 2014 (JP) 2014-143974
Apr. 17, 2015 (JP) 2015-085089

(51) Int. Cl. H01M 4/583; H01M 10/0568

(52) U.S. Cl. CPC H01M 4/583; H01M 10/0568; H01M 2004/021

(57) ABSTRACT

Provided is a power storage element, including: a positive electrode; a negative electrode containing a carbonaceous material as a negative-electrode active material; and a non-aqueous electrolytic solution obtained by dissolving an electrolyte in a non-aqueous solvent, wherein a crystallite size Lc₍₀₀₂₎ of the carbonaceous material in a c-axis direction is from 1.65 nm to 241.1 nm, and wherein cations of electrolyte ions are intercalated into and deintercalated from the negative electrode, and anions thereof are intercalated into and deintercalated from the positive electrode.

### BACKGROUND OF THE INVENTION

1. Field of the Invention

The present invention relates to a power storage element.

2. Description of the Related Art

Lithium ion batteries (LIB) are one kind of power storage elements, and useful for applications with short charging/discharging cycles because they can be charged and discharged repeatedly.

A lithium salt such as LiPF₆ is used as a salt soluble in a non-aqueous solvent used in the lithium ion batteries, for example, a carbonate ester such as propylene carbonate and ethylene carbonate. However, when the lithium salt is used as a solute, there are possibilities that a metal Li may be deposited. Once a metal Li is deposited, there is a risk of short-circuiting. Actually, many fire breakout accidents have happened so far due to alleged short-circuiting accidents. It has been reported that when graphite is used as a negative-electrode active material of the lithium ion batteries, a metal Li is likely to deposit, particularly at a low temperature (about 0° C. or lower).

Further, it has been reported that during an overcharged state, oxygen separating from an oxide and the electrolytic solution react with each other at the positive electrode to cause a thermal runaway, leading to heat generation and fire breakouts.

Meanwhile, as a salt soluble in the carbonate ester, there is an organic salt composed of a macrocation (e.g., a non-metallic cation such as of an ammonium salt) and a macroanion (e.g., a PF₆ anion and BF₄ anion). If the organic salt can be used as an electrolyte of the lithium ion batteries, it is possible to significantly reduce the risks involved in the lithium ion batteries, because the organic salt is free of metallic cations such as a lithium ion.

However, the non-metallic cation has an ionic diameter much larger than that of a metallic cation, and it is difficult for the non-metallic cation to be intercalated into a specific site of a solid crystal. Hence, the non-metallic cation has not been employed as a main electrolyte of the lithium ion batteries.

Power storage elements that conventionally have been known to use a lithium salt (a Li-containing oxide) as an electrolyte are lithium ion batteries (LIB) that contains graphite in an electrolytic solution as a negative electrode. The power storage mechanism of the LIB is based on a change of the graphite to a compound represented by LiC₆ upon an intercalation reaction of the lithium ion (Li ion) into the graphite lattice (see U.S. Pat. No. 4,423,125).

Earlier than this, Goodenough et al. from Great Britain have reported that deintercalation of Li from a Li-containing oxide such as lithium cobaltate (LiCoO₂) is possible (see U.S. Pat. No. 4,302,518).

Based on the conventional arts, there are proposed new-type lithium ion batteries of which power storage mechanism is based on intercalation and deintercalation of Li ion, with a Li-containing oxide used as a positive electrode and a carbon compound such as graphite used as a negative electrode.

Currently, the new-type lithium ion batteries have the top sales volume as chargeable/dischargeable secondary batteries, and have grown to overwhelm the lead batteries used for starting automobiles, etc.

In the lithium ion batteries (LIB), when a Li ion or the like is intercalated into a crystal lattice, the crystal lattice expands. As a result, according to X-ray diffractometry, the position of a peak of a diffraction line from a specific crystal face shifts to a lower angle. This shift is a phenomenon unique to an intercalation reaction. According to a power storage mechanism of an electric double layer capacitor (EDLC), there occurs no intercalation of an ion into a crystal lattice. That is, the power storage mechanism of the EDLC is based not on an intercalation reaction, but on adsorption and desorption of an ion on the surface of particles, and no XRD peak position shift is observed in the EDLC. Hence, the difference in the power storage mechanism between the LIB and the EDLC can be confirmed by the XRD method.

It has been reported that a Li ion, a K ion, etc. are monovalent cations confirmed to be intercalated into graphite (see ‘Graphite Intercalation Compound’ authored by Watanabe, published by Kindai Henshu Ltd., Page 236). Further, because a Na ion is also intercalation-reactive, there have also been proposed Na ion batteries using an inexpensive Na ion, although this makes the batteries' electric capacity smaller.

In the lithium ion batteries (LIB), graphite is mainly used as a negative electrode in terms of energy density. However, the intercalation speed of a Li ion into the graphite is slow. Therefore, deposition of a metal Li is observed, particularly at a low temperature (0° C. or lower). If the metal Li grows along with charging and discharging to thereby reach the positive electrode, which is the antipole, there are possibilities that the positive electrode and negative electrode may be short-circuited, leading to possibilities that the lithium ion batteries (LIB) may cause accidents such as fire breakout and explosion, and actually resulting in many accidents.

Furthermore, there are electric double layer capacitors as an example using a metal-free ion. However, the electric double layer capacitors generally have a small capacity, and increase of the capacity is eagerly anticipated.

Hence, in order to improve the safety of power storage elements drastically, development of a power storage element that is extremely safe based on a capability of preventing deposition of a metal on a negative electrode by using a metallic ion-free electrolytic solution, and that has a capacity larger than that of an electric double layer capacitor is currently strongly demanded.

### SUMMARY OF THE INVENTION

A power storage element of the present invention as a means for solving the problems described above is a power storage element, including:

a positive electrode;

a negative electrode containing a carbonaceous material as a negative-electrode active material; and

a non-aqueous electrolytic solution obtained by dissolving an electrolyte in a non-aqueous solvent,

wherein a crystallite size Lc₍₀₀₂₎ of the carbonaceous material in a c-axis direction is from 1.65 nm to 241.1 nm, and

wherein cations of electrolyte ions are intercalated into and deintercalated from the negative electrode, and anions thereof are intercalated into and deintercalated from the positive electrode.

According to the present invention, it is possible to provide a power storage element that can prevent deposition of a metal on a negative electrode, is extremely safe as compared with conventional power storage elements, and has a capacity larger than that of an electric double layer capacitor.

### BRIEF DESCRIPTION OF THE DRAWINGS

FIG. 1 is an assembly diagram showing an example of a power storage element of the present invention.

FIG. 2 is a graph showing a result of a constant-current charge-discharge test of Example 1.

FIG. 3 is a graph showing a result of a constant-current charge-discharge test of Example 2.

FIG. 4 is a graph showing a result of a constant-current charge-discharge test of Example 3.

FIG. 5 is a graph showing a result of a constant-current charge-discharge test of Example 4.

FIG. 6 is a graph showing a result of a constant-current charge-discharge test of Example 5.

FIG. 7 is a graph showing a result of a constant-current charge-discharge test of Example 6.

FIG. 8 is a graph showing a result of a constant-current charge-discharge test of Example 8.

FIG. 9 is an exemplary diagram showing a crystallite size Lc₍₀₀₂₎ and an average lattice spacing d₍₀₀₂₎ of a carbonaceous material in a c-axis direction.

### DETAILED DESCRIPTION OF THE INVENTION

### Power Storage Element

A power storage element of the present invention includes a positive electrode, a negative electrode, and a non-aqueous electrolytic solution, preferably includes a separator, and further includes other members according to necessity.

In order to solve the problems described above, the present inventors have conducted earnest studies focusing on the fact that an organic salt (electrolyte) containing a monovalent cation other than a metallic ion and having a macroion diameter is soluble in a carbonate ester salt, and as a result, discovered that a power storage element that is very safe compared with conventional lithium ion secondary batteries can be obtained if it is possible to develop an electrode material into which a monovalent macrocation other than a metallic ion can be intercalated, because such a material allows for ignoring deposition of a metal as a matter of mechanism.

In the present invention, a carbonaceous material used as the negative electrode has a crystallite size Lc₍₀₀₂₎ of 241.1 nm or less, preferably 123.92 nm or less in a c-axis direction. When Lc₍₀₀₂₎ is 241.1 nm or less, there is an advantage that intercalation of a macroion into the carbonaceous material can be confirmed. Note that the crystallite size Lc₍₀₀₂₎ in the c-axis direction is 1 nm or greater.

The crystallite size Lc₍₀₀₂₎ of the carbonaceous material can be measured with, for example, MINI FLEX II-TYPE X-RAY DIFFRACTOMETER manufactured by Rigaku Corporation according to Gakushin method (Carbon-X), using a Cu-Kα ray that is colored in a single color with Ni, and using high purity silicon as a standard substance.

It is possible to realize a carbonaceous material satisfying the crystallite size Lc₍₀₀₂₎ in the c-axis direction mentioned above, by subjecting a carbonaceous material such as graphite or a carbon material to an expansion treatment.

The expansion treatment is not particularly limited, and an arbitrary treatment may be selected according to the purpose. For example, there is a method of bringing a carbonaceous material into contact with a mixed acid of a 98% by mass sulfuric acid (9 parts by mass) and a 60% by mass nitric acid (1 part by mass) for 2 hours to obtain a graphite-sulfuric acid intercalation compound, washing the compound with water, drying it, and then heating it in an electric furnace of from 800° C. to 1,000° C.

An ionic radius of the (macro-) cation is preferably 0.2 nm or greater, and more preferably 0.4 nm or greater (see “Forefront of Development of Next-Generation Capacitor”, supervised by Naoi and Nishino, Page 56, NTS Inc. (2009)). Meanwhile, an ionic radius of a Li ion is 0.076 nm. There have been discovered quite few electrode active materials into which a macrocation having an ionic radius of 0.2 nm or greater can be intercalated. Hence, with a view to developing an extremely safe organic ion battery, attempts were made to discover or develop a graphite-containing carbonaceous material into which a macrocation can be intercalated.

The ionic radiuses of a Li ion, a Na ion, and a K ion are 0.076 nm, 0.095 nm, and 0.13 nm, respectively. The ionic radiuses of a BF₄ anion and a PF₆ anion, which are counter anions to produce salts with the macrocation are 0.23 nm and 0.25 nm, respectively.

As used herein, a “macroion” refers to an ion having an ionic radius of 0.2 nm or greater.

A power storage element that is well-known to use an organic salt containing such a macrocation as described above as an electrolyte is an electric double layer capacitor (EDLC) formed of activated charcoal immersed in an electrolytic solution.

However, the power storage mechanism of the electric double layer capacitor (EDLC) is based on an absorption/desorption reaction of such organic ions into an electrode, but not an intercalation or deintercalation reaction. Due to the difference in the power storage mechanism, the electric double layer capacitor (EDLC) has a low energy density, which is from about 0.9 Wh/kg to 7.4 Wh/kg, which is equal to or less than 10% of the energy density of the lithium ion batteries (LIB).

The electric double layer capacitor (EDLC) uses activated charcoal as an active material. The activated charcoal is an amorphous carbon treated to have a BET specific surface area of about 1,000 m²/g or greater by various synthesis methods such as alkali activation method and water vapor activation method. This treatment is because a greater energy density can be obtained if there is a greater surface area to and from which ions are absorbed and desorbed, in order for the power storage mechanism to be based on an absorption/desorption reaction. As compared with this, lithium ion batteries having an intercalation or deintercalation reaction do not use a compound having such an abnormally large surface area.

It is possible to easily distinguish whether the power storage mechanism is based on an absorption/desorption reaction or an intercalation/deintercalation reaction, as follows.

(1) A case where distinction is based on a charge/discharge curve: a relationship between a charge voltage (or a discharge voltage) and an electric capacity is expressed as a linear relationship in the case of an absorption/desorption reaction, and as a curve having a plateau (flat portion) in the case of an intercalation/deintercalation reaction.

(2) A method of basing distinction on an XRD curve of an electrode active material: there is no change at all between XRD curves before and after charging in the case of an absorption/desorption reaction, whereas in the case of an intercalation/deintercalation reaction, crystal lattice expansion due to intercalation is observed, and when the electrode active material is a carbonaceous material, the position of a peak based on a (002) face shifts to a lower angle.

As described above, the power storage mechanism of the electric double layer capacitor is based on absorption/desorption of a cation and an anion, but not on an intercalation/deintercalation reaction. An absorption/desorption reaction has a low power storage ability, resulting in an energy density of from about 4 Wh/kg to 6 Wh/kg. With a view to increasing the energy density of the power storage element, there has also been reported a so-called lithium ion capacitor in which the power storage mechanism of either one of the positive electrode and the negative electrode is based on intercalation/deintercalation as in lithium ion batteries.

On the other hand, in the lithium ion batteries, an extremely small lithium cation having an ionic radius of 0.08 nm is used. Graphite has too high a crystallinity to form a graphite-lithium intercalation compound LiC₆ having an exact theoretical value. That is, it is necessary to bring its crystal lattice constant Co close to the value of natural graphite. As a result, it becomes possible for a small lithium ion to be intercalated.

In sum, the power storage element of the present invention uses a negative electrode containing as a negative-electrode active material, a carbonaceous material into and from which a macrocation can be intercalated and deintercalated, and uses a non-aqueous electrolytic solution free of a metallic ion in combination, which makes it possible to provide an extremely safe power storage element because the electrolytic solution does not contain a metallic ion, particularly a Li ion, and there will be no deposition of a metal during charging.

### <Negative Electrode>

The negative electrode is not particularly limited except that it should contain a negative-electrode active material, and an appropriate negative electrode may be selected according to the purpose. Examples thereof include a negative electrode that includes a negative electrode material containing a negative-electrode active material over a negative electrode power collector.

The shape of the negative electrode is not particularly limited, and may be appropriately selected according to the purpose. Examples include a flat plate shape.

### <<Negative Electrode Material>>

The negative electrode material contains at least a negative-electrode active material, and contains a binder, a conducting agent, etc. according to necessity.

### —Negative-Electrode Active Material—

A carbonaceous material is used as the negative-electrode active material. The carbonaceous material contains “graphite” and “carbon”.

In the present specification, “graphite” refers to “a graphite-like carbonaceous material” in which many layers of planes of hexagonally-bonded carbon atoms are stratified. That is, it refers to a graphite-like carbonaceous material in which an average lattice spacing d₍₀₀₂₎ between carbon layer planes is less than 0.344 nm. A common crystalline structure of graphite is a mixture of a hexagonal structure and a rhombohedral structure. However, a synthetic graphite having a structure substantially free of a rhombohedral structure is also available as a material of a power storage element.

A carbonaceous material in which an average lattice spacing d₍₀₀₂₎ between carbon layer planes is 0.344 nm or greater is not referred to as “graphite”, but is referred to as “carbon” simply or “a non-graphite-like carbonaceous material” in the present specification.

Hence, in the present specification, difference between “graphite” and “carbon” is determined by whether an average lattice spacing d₍₀₀₂₎ between carbon layer planes is less than 0.344 nm or equal to or greater than 0.344 nm.

A graphite material needs to have as small a crystallite size Lc as possible in the c-axis direction, in order to qualify as the negative-electrode active material into and from which a macrocation can be intercalated and deintercalated (inserted or eliminated). In order for the Lc value to be small, interlayer disconnection is necessary in the graphite. As the result of many studies, it turns out that a method suitable for achieving this purpose is a method based on production of expanded graphite. When using a non-graphite carbonaceous material as the negative-electrode active material, it is important to ease its crystal structure as much as possible and facilitate insertion and elimination of a macrocation, although basically its Co is larger than that of graphite.

That is, a carbonaceous material that is used as the negative-electrode active material and into which a macrocation can be intercalated has a crystallite size Lc₍₀₀₂₎ of 241.1 nm or less, and preferably 123.92 nm or less in the c-axis direction.

When Lc₍₀₀₂₎ is greater than 241.1 nm, there will be not enough macrocations to be doped (intercalated), which not only makes it impossible to obtain a sufficient charge level, but also makes it likely for the electric capacity of the power storage element to be low because this makes a ratio of a discharge level to a charge level (i.e., efficiency) low.

The crystallite size Lc₍₀₀₂₎ of the carbonaceous material can be measured with, for example, MINI FLEX II-TYPE X-RAY DIFFRACTOMETER manufactured by Rigaku Corporation according to Gakushin method (Carbon-X), using a Cu-Kα ray that is colored in a single color with Ni, and using high purity silicon as a standard substance.

In a given form, the negative-electrode active material is expanded graphite. A method for producing the expanded graphite is not particularly limited, and an appropriate method may be selected according to the purpose. Examples include (1) a method of treating a graphite material such as natural graphite, kish graphite, and highly crystalline pyrolytic graphite with a mixed acid of a sulfuric acid and a nitric acid, (2) a method of synthesizing expanded graphite by immersing graphite in a liquid mixed with a strong oxidant such as a perchlorate salt, a permanganate salt, and a dichromate salt, and reacting the graphite with the liquid, and (3) a method of rapidly heating and thereby expanding a graphite-sulfuric acid intercalation compound obtained by electrochemically oxidizing graphite in a sulfuric acid.

The electrode active material may be the expanded graphite produced by the methods described above as it is, or may be expanded graphite made into flakes or particles. Through this operation, the Lc₍₀₀₂₎ value becomes even smaller. Examples of the method for obtaining particles include a method of ultrasonically fracturing expanded graphite, and a method of grinding expanded graphite with a grinder. Further, after particles are obtained, they may be densified.

The ultrasonically fracturing method is a method in which expanded graphite is immersed in a liquid, and irradiated with ultrasonic waves in this state. Examples of the liquid include water, ketones such as acetone, alcohols such as methyl alcohol, ethyl alcohol, and butyl alcohol, and a paraffin-based solvent such as hexane.

Examples of the grinding method using the grinder include a method of grinding expanded graphite according to a wet method with a grinder such as a ball mill and a Henschel mixer using steel balls, or balls made of ceramics such as alumina, or highly wear-resistant media made of rod-like steel or ceramics.

The densified graphite particles are graphite particles having a high bulk density, and it is generally preferable that their tap density be from 0.7 g/cm³ to 1.3 g/cm³.

It is preferable that the densified graphite particles contain spindle-shaped graphite particles having an aspect ratio of from 1 to 5 in an amount of 10% by volume or higher, or contain disk-shaped graphite particles having an aspect ratio of from 1 to 10 in an amount of 50% by volume or higher.

The densified graphite particles can be produced by densifying material graphite particles. The material graphite particles may be any of natural graphite and artificial graphite. However, natural graphite is preferable in terms of high crystallinity and easy availability. It is possible to grind native graphite and use the obtained product as the material graphite particles, but it is also possible to use the flake-shaped graphite particles as the material graphite particles.

The densification treatment is performed by applying an impact to the material graphite particles. A densification treatment using a vibrational mill is more preferable because it can obtain a particularly high degree of densification. Examples of the vibrational mill include a vibrational ball mill, a vibrational disk mill, and a vibrational rod mill.

When scale-like material graphite particles having a large aspect ratio are subjected to densification, the material graphite particles become secondary particles while being overlaid together mainly at the graphite's basal plane (basic surface), and at the same time, the overlaid secondary particles are scraped off at the edges roundly to change to a thick disk shape having an aspect ratio of from 1 to 10 or a thick spindle shape having an aspect ratio of from 1 to 5 to be transformed to graphite particles having a small aspect ratio.

As the result of the graphite particles being transformed to particles having a small aspect ratio, graphite particles having an excellent isotropy and a high tap density can be obtained, even though graphite particles are highly crystalline. Hence, in a case when molding these particles into a polarizable electrode, it is possible to have graphite contained in a graphite slurry at a high concentration, and the electrode to be molded will contain graphite at a high density.

The negative-electrode active material may be a non-graphite carbonaceous material. As properties of the non-graphite carbonaceous material to enable a macrocation to be intercalated thereinto, a crystallite size Lc₍₀₀₂₎ in the c-axis direction is preferably 1 nm or greater, and the crystallite size Lc₍₀₀₂₎ in the c-axis direction is 241.1 nm or less and preferably 123.92 nm or less.

The non-graphite carbonaceous material is so-called soft carbon obtained by pulverizing a petroleum-based coke, or a coal-based coke, or both thereof, and burning the obtained product at 2,000° C. or lower, for example, at from 900° C. to 1,300° C. Alternatively, the non-graphite carbonaceous material may be hard carbon, which hardly changes to graphite.

### —Binder—

The binder is not particularly limited, and an arbitrary binder may be selected according to the purpose. Examples thereof include: a fluorine-based binder such as polyvinylidene fluoride (PVDF), and polytetrafluoroethylene (PTFE); an ethylene-propylene-butadiene rubber (EPBR); a styrene-butadiene rubber (SBR); an isoprene rubber; and carboxymethyl cellulose (CMC). One of these may be used alone, or two or more of these may be used in combination. Among these, a fluorine-based binder such as polyvinylidene fluoride (PVDF) and polytetrafluoroethylene (PTFE), and carboxymethyl cellulose are preferable.

### —Conducting Agent—

The conducting agent is not particularly limited, and an arbitrary conducting agent may be selected according to the purpose. Examples thereof include a metallic material such as copper and aluminium, and a carbonaceous material such as carbon black and acetylene black. One of these may be used alone, or two or more of these may be used in combination.

A mixing mass ratio among the carbonaceous material, the conducting agent, and the binder (carbonaceous material:conducting agent:binder) is preferably 10 to 1:0.5 to 10:0.5 to 0.25.

### <<Negative Electrode Power Collector>>

The material, shape, size, and structure of the negative electrode power collector are not particularly limited, and may be appropriately selected according to the purpose.

The material of the negative electrode power collector is not particularly limited except that it should be a conductive material, and may be appropriately selected according to the purpose. Examples thereof include stainless steel, nickel, aluminium, copper, and titanium.

The shape of the power collector is not particularly limited, and may be appropriately selected according to the purpose.

The size of the power collector is not particularly limited except that it should be a size applicable in a power storage element, and may be appropriately selected according to the purpose.

### —Method for Producing Negative Electrode—

The negative electrode can be produced by applying over the negative electrode power collector, a negative electrode material slurried by adding the binder, the conductive agent, a solvent, etc. to the negative-electrode active material according to necessity, and drying the applied product. The solvent is not particularly limited, and an arbitrary solvent may be selected according to the purpose. Examples thereof include an aqueous solvent, and an organic solvent. Examples of the aqueous solvent include water and alcohol. Examples of the organic solvent include N-methyl-2-pyrrolidone (NMP), and toluene.

It is also possible to form the mixture of the negative-electrode active material with the binder, the conducting agent, etc. into a sheet electrode by rolling, or form the mixture into a pellet electrode by compression molding, or form a thin film of the negative-electrode active material over the negative electrode power collector by such a method as vapor deposition, sputtering, and plating.

An obtained sheet-shaped electrode is bonded with a collector electrode, to thereby obtain an electrode member. A material to be used as the collector electrode is a material having a shape commonly used in a power storage element. Examples of the shape of the collector electrode include a sheet shape, a prism shape, and a cylindroid shape. A particularly preferable shape is a sheet shape or a foil shape. Examples of the material of the collector electrode include aluminium, copper, silver, nickel, and titanium.

### <Positive Electrode>

The positive electrode is not particularly limited except that it should contain a positive-electrode active material, and an arbitrary positive electrode may be selected according to the purpose. Examples thereof include a positive electrode that includes a positive electrode material containing a positive-electrode active material over a positive electrode power collector.

The shape of the positive electrode is not particularly limited, and may be appropriately selected according to the purpose. Examples thereof include a flat plate shape.

### <<Positive Electrode Material>>

The positive electrode material is not particularly limited, and an arbitrary positive electrode material may be selected according to the purpose. Examples thereof include one that contains at least a positive-electrode active material, and further contains a conducting agent, a binder, a thickener, etc. according to necessity.

### —Positive-Electrode Active Material—

As the positive-electrode active material, a carbonaceous material into and from which a macroanion, for example, a BF₄ anion or a PF₆ anion can be intercalated and deintercalated is used. In this case, combined use thereof with the negative electrode can realize a configuration of a power storage element that is safe and has a large electric capacity in an electrolytic solution system that is completely free of a metallic ion such as a lithium ion.

The carbonaceous material as the positive-electrode active material may be the same as the carbonaceous material described concerning the negative electrode.

### —Binder—

The binder is not particularly limited except that it should be stable in a solvent or a non-aqueous electrolytic solution used during production of the electrode, and an arbitrary binder may be selected according to the purpose. Examples thereof include: a fluorine-based binder such as polyvinylidene fluoride (PVDF), and polytetrafluoroethylene (PTFE); a styrene-butadiene rubber (SBR); an isoprene rubber; and carboxymethyl cellulose (CMC). One of these may be used alone, or two or more of these may be used in combination.

### —Thickener—

Examples of the thickener include carboxymethyl cellulose, methyl cellulose, hydroxymethyl cellulose, ethyl cellulose, polyvinyl alcohol, oxidized starch, starch phosphate, and casein. One of these may be used alone, or two or more of these may be used in combination.

### —Conducting Agent—

Examples of the conducting agent include a metallic material such as copper and aluminium, and a carbonaceous material such as carbon black and acetylene black. One of these may be used alone, or two or more of these may be used in combination.

### <<Positive Electrode Power Collector>>

The material, shape, size, and structure of the positive electrode power collector are not particularly limited, and may be appropriately selected according to the purpose.

The material of the positive electrode power collector is not particularly limited except that it should be a conductive material, and may be appropriately selected according to the purpose. Examples thereof include stainless steel, nickel, aluminium, copper, titanium, and tantalum. Among these, stainless steel and aluminium are particularly preferable.

The shape of the positive electrode power collector is not particularly limited, and may be appropriately selected according to the purpose.

The size of the positive electrode power collector is not particularly limited except that it should be a size applicable in a power storage element, and may be appropriately selected according to the purpose.

### —Method for Producing Positive Electrode—

The positive electrode can be produced by applying over the positive electrode power collector, a positive electrode material slurried by adding the binder, the thickener, the conductive agent, a solvent, etc. to the positive-electrode active material according to necessity, and drying the applied product. The solvent may the same as the solvent used for the negative electrode.

It is also possible to form the positive-electrode active material as it is into a sheet electrode by rolling, or form it into a pellet electrode by compression molding.

### <Non-Aqueous Electrolytic Solution>

The non-aqueous electrolytic solution is an electrolytic solution obtained by dissolving an electrolyte in a non-aqueous solvent. A non-aqueous electrolytic solution free of a metallic ion is to be used in terms of safety.

The non-aqueous electrolytic solution may be an ionic liquid that contains a macrocation and a macroanion but is free of a metallic ion.

### —Non-Aqueous Solvent—

As the non-aqueous solvent, a publicly-known aprotic low-dielectric-constant solvent is used. Examples thereof include ethylene carbonate, propylene carbonate, diethylene carbonate, acetonitrile, propionitrile, tetrahydrofuran, γ-butyrolactone, 2-methyl tetrahydrofuran, 1,3-dioxolan, 4-methyl-1,3-dioxolan, 1,2-dimethoxyethane, 1,2-diethoxyethane, diethylether, sulfolane, methylsulfolane, nitromethane, N,N-dimethylformamide, and dimethylsulfoxide. One of these may be used alone, or two or more of these may be used in combination.

### —Electrolyte—

As the electrolyte, an electrolyte of which electrolytic cation can be intercalated into the negative electrode, and of which electrolytic anion can be intercalated into the positive electrode is used.

A preferable electrolyte is an electrolyte of which electrolytic cation can be intercalated into the negative electrode, and of which electrolytic anion can be intercalated into and deintercalated from the positive electrode.

The electrolyte is preferably a salt containing a macrocation in terms of safety.

Examples of the macrocation of the electrolyte include: a cyclic quaternary ammonium ion and an aliphatic quaternary ammonium ion such as a tetraethyl ammonium (TEA) ion, a tetrabutyl ammonium (TBA) ion, and a triethylmethyl ammonium (TEMA) ion; a pyrrolidinium ion such as a spiro-(1,1′) bipyrrolidinium ion, a dimethyl pyrrolidinium ion, a diethyl pyrrolidinium ion, and an ethylmethyl pyrrolidinium (EMP) ion; a spiro-type bipyrrolidinium ion having a two-membered ring such as a spirobipyrrolidinium (SBP) ion; a tetraethyl phosphonium (TEP) ion; a trimethylalkyl ammonium ion which contains 2 to 10 carbon atoms in an alkyl group thereof; and an imidazolium derivative ion represented by the general formula 1 below. One of these may be used alone, or two or more of these may be used in combination. Among these, a tetraethyl ammonium (TEA) ion, a tetrabutyl ammonium (TBA) ion, a triethylmethyl ammonium (TEMA) ion, a pyrrolidinium ion, a spiro-type bipyrrolidinium ion having a two-membered ring, and an imidazolium derivative ion represented by the general formula 1 below are preferable.

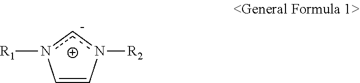

In the general formula 1 above, R₁ and R₂ may be the same as or different from each other, and are an alkyl group having 1 to 5 carbon atoms.

As the electrolyte, an electrolyte that contains at least one selected from the group consisting of non-metallic or half-metallic elements in the periods 1, 2, and 3 of the (long or short) periodic table, As, and Sb is used.

A salt containing a macroanion is preferable as such an electrolyte.

Examples of the anion of the electrolyte include a borate tetrafluoride ion (BF₄⁻), a phosphate hexafluoride ion (PF₆⁻), a perchlorate ion (ClO₄⁻), an arsenic hexafluoride ion (AsF₆⁻), an antimony hexafluoride ion (SbF₆⁻), a decachloroborate ion (B₁₀Cl₁₀²⁻), a perfluoromethyl sulfonyl ion (CF₃SO₂⁻), a perfluoromethyl sulfonate ion (CF₃SO₃⁻), B₁₂Cl₁₂²⁻, (CF₃SO₂⁻)N⁻, (CF₃SO₂)C⁻, and AlCl₄⁻. One of these may be used alone, or two or more of these may be used in combination.

The electrolyte may be a salt composed of the macrocation and the macroanion. The electrolyte may contain a lithium salt together with the salt composed of the macrocation and the macroanion. Use of the lithium salt makes it easier to increase the electric capacity of the power storage element, but on the other hand, use of the lithium salt as the electrolyte makes it likely for a metal Li to be deposited on the negative electrode. In order to prevent this, it is preferable that the lithium salt content be equal to or less than 50% by mass of the whole electrolyte content.

Examples of the lithium salt include lithium hexafluorophosphate (LiPF₆), lithium perchlorate (LiClO₄), lithium chloride (LiCl), lithium borofluoride (LiBF₄), LiB(C₆H₅)₄, lithium hexafluoroarsenide (LiAsF₆), lithium trifluoromethane sulfonate (LiCF₃SO₃), lithium bistrifluoromethyl sulfonylimide (LiN(CF₃SO₂)₂), and lithium bisperfluoroethyl sulfonylimide (LiN(C₂F₅SO₂)₂). One of these may be used alone, or two or more of these may be used in combination.

A non-aqueous electrolytic solution is obtained by dissolving the electrolyte in the non-aqueous solvent. The content of the electrolyte in the non-aqueous electrolytic solution is preferably from 0.8 mol % to 3.5 mol %, and more preferably from 1.0 mol % to 2.5 mol %. When the content of the electrolyte is less than 0.8 mol %, there will not be a sufficient number of ions to be contained, and a sufficient electric capacity may not be obtained. On the other hand, when the content of the electrolyte is greater than 2.5 mol %, the extra content will not contribute to the electric capacity.

### <Separator>

The separator is provided between the positive electrode and the negative electrode in order to prevent short-circuiting between the positive electrode and the negative electrode.

The material, shape, size, and structure of the separator are not particularly limited, and may be appropriately selected according to the purpose.

Examples of the material of the separator include: paper such as kraft paper, vinylon mixed paper, and synthetic pulp mixed paper; cellophane; a polyethylene graft film; a polyolefin non-woven cloth such as a polypropylene meltblown non-woven cloth; a polyamide non-woven cloth; a glass fiber non-woven cloth; and glass. One of these may be used alone, or two or more of these may be used in combination.

Examples of the shape of the separator include a sheet shape.

The size of the separator is not particularly limited except that it should be a size applicable in a power storage element, and may be appropriately selected according to the purpose.

The structure of the separator may be a single-layer structure or may be a multilayer structure.

### <Other Members>

The other members are not particularly limited, and arbitrary members may be selected according to the purpose. Examples thereof include an outer package can, and an electrode withdrawing line.

### <Production of Power Storage Element>

The power storage element is produced by assembling the positive electrode, the negative electrode, the non-aqueous electrolytic solution, and the separator into an appropriate form. Further, if necessary, other constituent members such as an outer package can may also be used.

The method for assembling the power storage element is not particularly limited, and an arbitrary method may be selected from commonly used methods. For example, a power storage element of which positive electrode and negative electrode are immersed in an organic electrolytic solution can be assembled by, for example, arranging a positive electrode and a negative electrode by overlapping electrode members via a separator, and then impregnating them with a non-aqueous electrolytic solution.

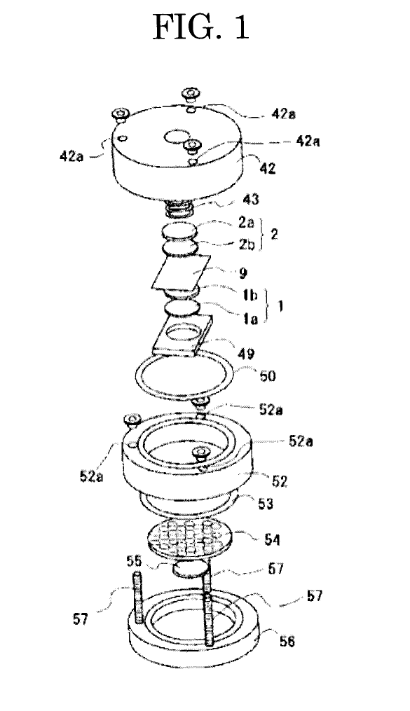

FIG. 1 is an exemplary exploded perspective diagram showing a basic configuration of the power storage element of the present invention. In FIG. 1, a reference sign 56 denotes a cup-like bottom cover.

A plurality of (three in FIG. 1) support poles 57, 57, and 57 are stood at appropriate intervals among one another over the top surface of the surrounding wall of the bottom cover 56. The support poles 57, 57, and 57 are configured to support an annular cell body 52 having an appropriate height dimension, and a cap-like top cover 42 having an appropriate weight.

The cell body 52 and the top cover 42 are bored near their surrounding edges to have insertion holes 52a, 52a and 52a, and 42a, 42a, and 42a through which the support poles 57, 57, and 57 are to be inserted. The cell body 52 and the top cover 42 are mounted over the bottom cover 56 in this order with the support poles 57, 57, and 57 inserted through their insertion holes 52a, 52a, and 52a, and 42a, 42a, and 42a. In this manner, a columnar casing is formed.

O-rings 53 and 50 are interposed between the bottom cover 56 and the cell body 52, and between the cell body 52 and the top cover 42 respectively, to prevent leakage of the electrolytic solution filled in the cell body 52.

In the cell body 52, a circular sheet-shaped reference electrode 55, a meshed retainer plate 54 obtained by opening a plurality of holes in a plate member, and a retainer guide 49 obtained by opening an aperture in the center of a rectangular thick plate are stacked in this order.

Further, a positive electrode 1 including: a conductive positive electrode power collector 1a; and a sheet-shaped positive electrode portion 1b, a separator 9, and a negative electrode 2 including: a sheet-shaped negative electrode portion 2b; and a conductive negative electrode power collector 2a are stacked in this order in the aperture of the retainer guide 49, and these members are retained by the retainer guide 49.

A spiral spring member 43 is provided in a hanging manner at the center of the internal surface of the top cover 42. A pressing force is applied to the reference electrode 55, the retainer plate 54, the positive electrode 1, the separator 9, and the negative electrode 2 by the elastic force of the spring member 43.

The bottom cover 56 and the cell body 52 are filled with an electrolytic solution, and the positive electrode 1, the separator 9, and the negative electrode 2 in the retainer guide 49 are hence immersed in the electrolytic solution.

### —Shape—

The shape of the power storage element of the present invention is not particularly limited, and an arbitrary shape may be selected according to the purpose from various shapes commonly employed. Examples of the shape include a cylinder type in which sheet electrodes and a separator are spiraled, a cylinder type having an inside-out structure in which pellet electrodes and a separator are used in combination, and a coin type in which pellet electrodes and a separator are stacked.

### <Application>

The power storage element of the present invention exhibits a very high safeness with no need of containing a metallic ion in the electrolytic solution. Therefore, the power storage element is excellent when applied in, for example, an electric vehicle, and a hybrid electric vehicle. Further, it is also suitably applied as a battery of which critical requisite is a high safety, such as a battery for a children's toy.

Examples of specific applications include a power supply and a backup power supply for a laptop computer, a stylus-operated computer, a mobile computer, an electronic book player, a cellular phone, a portable facsimile machine, a portable copier, a portable printer, a stereophone, a camcorder, a liquid crystal display TV set, a handheld cleaner, a portable CD player, an MD player, a transceiver, an electronic notepad, a calculator, a memory card, a portable tape recorder, a radio, a motor, a lighting apparatus, a toy, a game console, a clock, a strobe, a camera, etc.

### EXAMPLES

Examples of the present invention will be described below. The present invention is not limited to these Examples by any means.

### <Method for Analyzing Carbonaceous Material>

The crystallite size Lc₍₀₀₂₎ and the average lattice spacing d₍₀₀₂₎, in the c-axis direction, of the carbonaceous materials shown in Table 1 below were measured with MINI FLEX II-TYPE X-RAY DIFFRACTOMETER manufactured by Rigaku Corporation according to Gakushin method (Carbon-V, using a Cu-Kα ray that was colored in a single color with Ni, and using high purity silicon as a standard substance.

FIG. 9 shows an exemplary diagram of the crystallite size Lc₍₀₀₂₎ and the average lattice spacing d₍₀₀₂₎ in the c-axis direction.

### <Expansion Treatment for Carbonaceous Material>

Graphite or carbon-based materials shown in Table 1 below were brought into contact with a mixed acid of a 98% by mass sulfuric acid (9 parts by mass) and a 60% by mass nitric acid (1 part by mass) for 2 hours, to thereby obtain graphite-sulfuric acid intercalation compounds. They were washed with water, dried, and then subjected to an expansion treatment by heating in an electric furnace of from 800° C. to 1,000° C., to thereby obtain expanded carbonaceous materials.

The carbonaceous materials expanded under the above conditions had a slight variation in the crystallite size Lc₍₀₀₂₎ in the c-axis direction depending on their place of origin. However, as long as Lc₍₀₀₂₎ was 241.1 nm or less, intercalation of a macroion into the materials could be confirmed. The results are shown in Table 2.

A change in the lattice spacing due to the expansion treatment of the carbonaceous materials could be confirmed by SEM (electron microscope) observation.

TABLE 1

| Graphite or | d₍₀₀₂₎ | Lc₍₀₀₂₎ | |
|---|---|---|---|
| carbon material | (nm) | (nm) | Remarks |
| E-Gr | 0.343 | 74.90 | obtained by subjecting product name: CHINA |
| | | | EXPANDED GRAPHITE to above expansion treatment |
| F-Gr (bare) | 0.337 | 123.92 | obtained by ultrasonically fracturing E-Gr |
| F-Gr1600 | 0.335 | 41.70 | obtained by treating F-Gr (bare) at 1,600° C. |
| MCMB6-28 | 0.337 | 106.6 | Graphite manufactured by Osaka Gas Co., Ltd. |
| ANC-Su-2 | 0.348 | 1.65 | obtained by subjecting soft carbon manufactured by |
| | | | Saga University to above expansion treatment (900° C.) |
| ANC-Su-3 | 0.348 | 3.46 | obtained by subjecting soft carbon manufactured by |
| | | | Saga University to above expansion treatment (950° C.) |
| ANC-Su-4 | 0.3445 | 5.83 | obtained by subjecting soft carbon manufactured by |
| | | | Saga University to above expansion treatment (1,000° C.) |
| ANC-Su-5 | 0.344 | 5.15 | obtained by subjecting soft carbon manufactured by |
| | | | Saga University to above expansion treatment (1,050° C.) |
| E-NGC | 0.350 | 26.50 | obtained by subjecting nanogate carbon YO12 to above |
| | | | expansion treatment (950° C.) |
| MAGC | 0.337 | 255.35 | Graphite manufactured by Hitachi Chemical Co., Ltd. |
| MAGD | 0.337 | 255.35 | Graphite manufactured by Hitachi Chemical Co., Ltd. |
| GDA S-2-0 | 0.3357 | 241.10 | obtained by subjecting scale-like graphite manufactured by |
| | | | Saga University to above expansion treatment (900° C.) |
| NC-C | 0.336 | 430.60 | obtained by subjecting natural graphite manufactured |
| | | | by Saga University to above expansion treatment |
| YM-P | 0.3471 | 15.13 | obtained by subjecting hard carbon manufactured by Kureha |
| | | | Corporation to above expansion treatment (950° C.) |

Table 2 shows the conditions of intercalation between the graphite or carbon materials shown in Table 1 and macroions. Specific conditions of charge/discharge curves will be mentioned in Examples 1 to 6 and 8.

TABLE 5

| Graphite | | | | | | | | | | |
|---|---|---|---|---|---|---|---|---|---|---|
| or carbon | Lc₍₀₀₂₎ | Cation | | | | | | | | |
| material | (nm) | TEA | TBA | TEMA | DMP | DEP | EMP | SBP | TEP | IMD |
| ANC-Su-2 | 1.65 | present | present | present | present | present | present | present | present | present |
| ANC-Su-3 | 3.46 | present | present | present | present | present | present | present | present | present |
| ANC-Su-5 | 5.15 | present | present | present | present | present | present | present | present | present |
| ANC-Su-4 | 5.83 | present | present | present | present | present | present | present | present | present |
| YM-P | 15.13 | present | present | present | present | present | present | present | present | present |
| E-NGC | 26.50 | present | present | present | present | present | present | present | present | present |
| F-Gr1600 | 41.70 | present | present | present | present | present | present | present | present | present |
| E-Gr | 74.90 | present | present | present | present | present | present | present | present | present |
| MCMB | 106.6 | present | present | present | present | present | present | present | present | present |
| 6-28 | | | | | | | | | | |
| F-Gr | 123.92 | present | present | present | present | present | present | present | present | present |
| (bare) | | | | | | | | | | |
| GDA S-2-0 | 241.10 | present | present | present | present | present | present | present | present | present |
| MAGC | 255.35 | absent | absent | absent | absent | absent | absent | absent | absent | absent |
| MAGD | 255.35 | absent | absent | absent | absent | absent | absent | absent | absent | absent |
| NC-C | 430.60 | absent | absent | absent | absent | absent | absent | absent | absent | absent |

In Table 2: “present” means “with a plateau”. In Table 2: “absent” means “with no plateau”.

Here, as a charge/discharge curve, the relationship between a charge voltage (or a discharge voltage) and an electric capacity is a linear relationship (“with no plateau (flat portion)”) in the case of an absorption/desorption reaction, whereas the relationship is “with a plateau (flat portion)” in the case of an intercalation/deintercalation reaction.

The abbreviations in Table 2 represents the followings.

*TEA: tetraethyl ammonium ion (with an ionic radius of 0.459 nm)
*TBA: tetrabutyl ammonium ion (with an ionic radius of 0.4 nm)
*TEMA: triethylmethyl ammonium ion (with an ionic radius of 0.434 nm)
*DMP: dimethyl pyrrolidinium ion (with an ionic radius of 0.420 nm)
*DEP: diethyl pyrrolidinium ion (with an ionic radius of 0.441 nm)
*EMP: ethylmethyl pyrrolidinium ion (with an ionic radius of 0.426 nm)
*SBP: spirobipyrrolidinium ion (with an ionic radius of 0.430 nm)
*TEP: tetraethyl phosphonium ion (with an ionic radius of 0.4 nm)
*IMD: imidazolium derivative ion (with an ionic radius of 0.4 nm)

From the results of Table 1 and Table 2, it was revealed that no intercalation could be confirmed in a carbonaceous material of which crystallite size Lc₍₀₀₂₎ in the c-axis direction was greater than 241.1 nm.

### Example 1

### Production of Power Storage Element

### —Production of Negative Electrode—

Expanded graphite particles “E-Gr” in Table 1 (3 g), acetylene black (manufactured by Denki Kagaku Kogyo Kabushiki Kaisha) (0.2 g), and a polytetrafluoroethylene powder (manufactured by Du Pont-Mitsui Fluorochemicals Co., Ltd.) (0.09 g) were mixed, and kneaded with an agate mortar. The obtained kneaded product was formed into a sheet shape having a uniform thickness of 0.15 mm with a forming machine, to thereby produce a negative electrode.

### —Production of Positive Electrode—

Expanded graphite particles “E-Gr” in Table 1 (3 g), acetylene black (manufactured by Denki Kagaku Kogyo Kabushiki Kaisha) (0.2 g), and a polytetrafluoroethylene powder (manufactured by Du Pont-Mitsui Fluorochemicals Co., Ltd.) (0.09 g) were mixed, and kneaded with an agate mortar. The obtained kneaded product was formed into a sheet shape having a uniform thickness of 0.15 mm with a forming machine, to thereby produce a positive electrode.

The obtained negative electrode sheet and positive electrode sheet were punched into a disk shape having a diameter of 20 mm, and assembled to an electrode cell shown in FIG. 1. At the time, a copper foil was used as a collector electrode, and glass was used as a separator. The obtained electrode cell was dried in a vacuum at 140° C. for 24 hours, and then cooled.

Next, spirobipyrrolidinium tetrafluoroborate (SBPBF₄) was dissolved in propylene carbonate (PC) such that it would become 2.0 mol %, to thereby prepare a non-aqueous electrolytic solution. The obtained non-aqueous electrolytic solution was filled in the electrode cell, to thereby produce a power storage element.

### <Constant-Current Charge-Discharge Test>

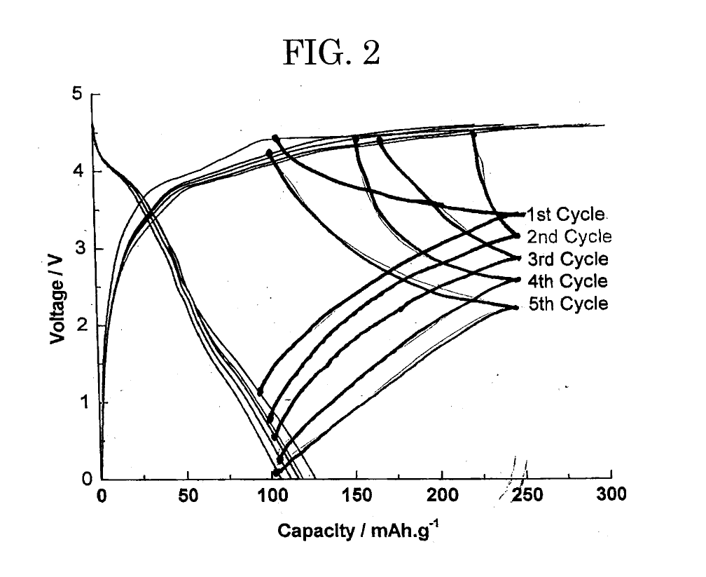

The produced power storage element was connected to a charge-discharge testing apparatus (“CDT-RD20” manufactured by Power Systems Co., Ltd.), and subjected to a constant-current charge-discharge test at 1 mA. The result is shown in FIG. 2.

From the result of FIG. 2, it can be seen that the capacity of the power storage element of Example 1 exceeded 100 mAh/g. It could be derived from this fact that intercalation of macroanions into graphite caused macrocations that consequently became excessive in the non-aqueous electrolytic solution to be intercalated, due to the necessity that cations and anions should be balanced in the non-aqueous electrolytic solution.

### Example 2

### Production of Power Storage Element

A power storage element was produced in the same manner as in Example 1, except that “E-Gr” in Table 1, which was used in Example 1, was changed to “F-Gr (bare)” in Table 1, which was obtained by ultrasonic fracturing.

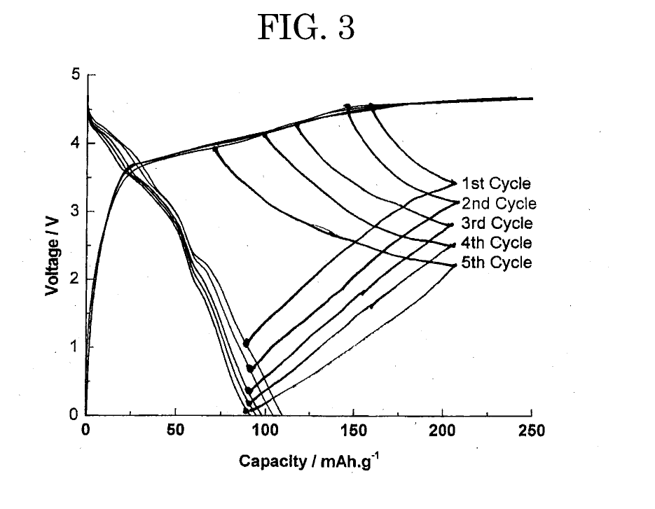

The produced power storage element was subjected to a constant-current charge-discharge test in the same manner as in Example 1. The result is shown in FIG. 3.

From the result of FIG. 3, it can be seen that in the charge curve plotting capacity increase along with voltage rise, an inflection point appeared at 3.6 V, and a flat portion appeared after this. Hence, it was revealed that intercalation occurred in the power storage element of Example 2.

### Example 3

### Production of Power Storage Element

A power storage element was produced in the same manner as in Example 1, except that the negative electrode was changed to “GDA S-2-0” in Table 1, which was a scale-like graphite, the positive electrode was changed to “NG0”, which was natural graphite, and the electrolytic solution was changed to 1M TEMA (trimethylethyl ammonium)-BF₄PC (tetrafluoroborate propylene carbonate) from those used in Example 1.

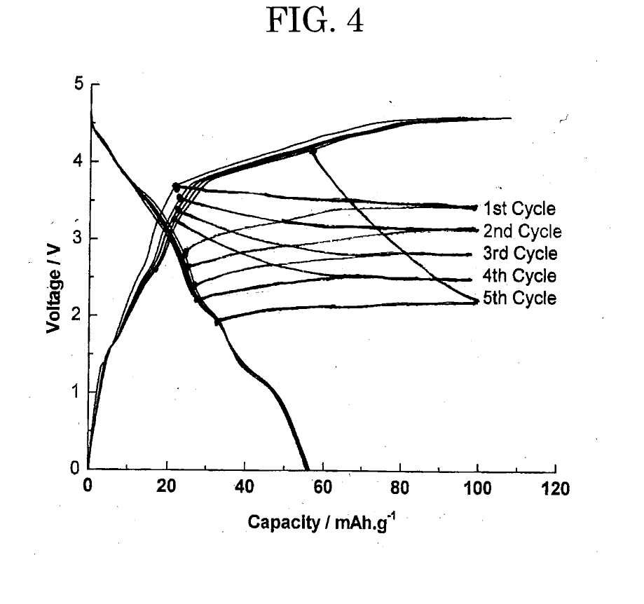

The produced power storage element was subjected to a constant-current charge-discharge test in the same manner as in Example 1. The result is shown in FIG. 4.

From the result of FIG. 4, it can be seen that in the charge curve plotting capacity increase along with voltage rise, an inflection point appeared at 3.8 V, and a flat portion appeared after this. Hence, it was revealed that intercalation occurred in the power storage element of Example 3.

### Example 4

### Production of Power Storage Element

A power storage element was produced in the same manner as in Example 3, except that the non-aqueous electrolytic solution was changed to 1M SBP-BF₄PC (spirobipyrrolidinium-tetrafluoroborate propylene carbonate) from Example 3.

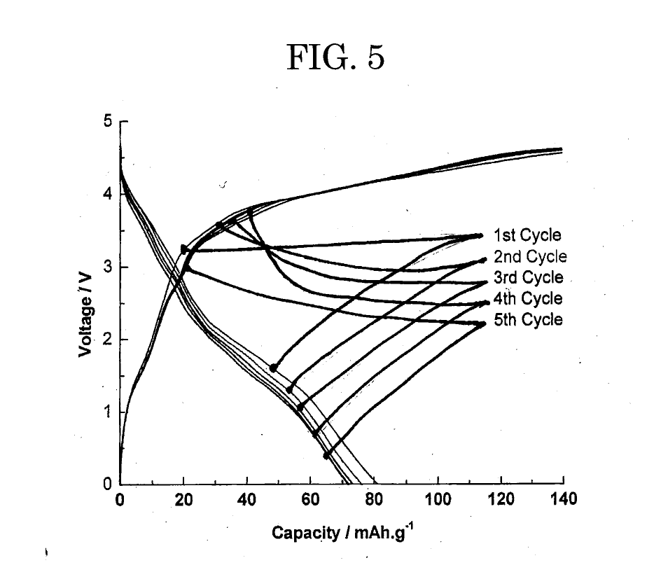

The produced power storage element was subjected to a constant-current charge-discharge test in the same manner as in Example 1. The result is shown in FIG. 5.

From the result of FIG. 5, it can be seen that in the charge curve plotting capacity increase along with voltage rise, an inflection point appeared at 3.5 V or higher, and a flat portion appeared after this. Hence, it was revealed that intercalation occurred in the power storage element of Example 4.

### Example 5

### Production of Power Storage Element

A power storage element was produced in the same manner as in Example 3, except that the negative electrode was changed from “GDA S-2-0” in Table 1, which was a scale-like graphite used in Example 3 to “E-Gr” in Table 1.

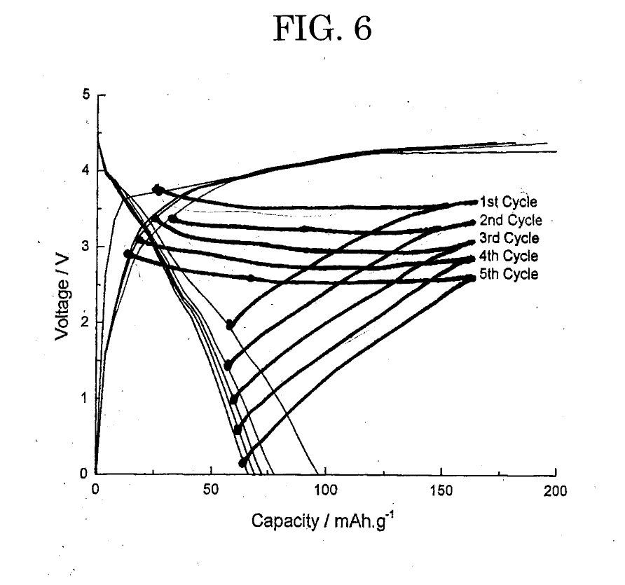

The produced power storage element was subjected to a constant-current charge-discharge test in the same manner as in Example 1. The result is shown in FIG. 6.

From the result of FIG. 6, it can be seen that in the charge curve plotting capacity increase along with voltage rise, an inflection point appeared at 3.5 V or higher, and a flat portion appeared after this. Hence, it was revealed that intercalation occurred in the power storage element of Example 5.

### Example 6

### Production of Power Storage Element

A power storage element was produced in the same manner as in Example 5, except that the non-aqueous electrolytic solution was changed to 1.5 M SBP-BF₄PC (spirobipyrrolidinium-tetrafluoroborate propylene carbonate) from Example 5.

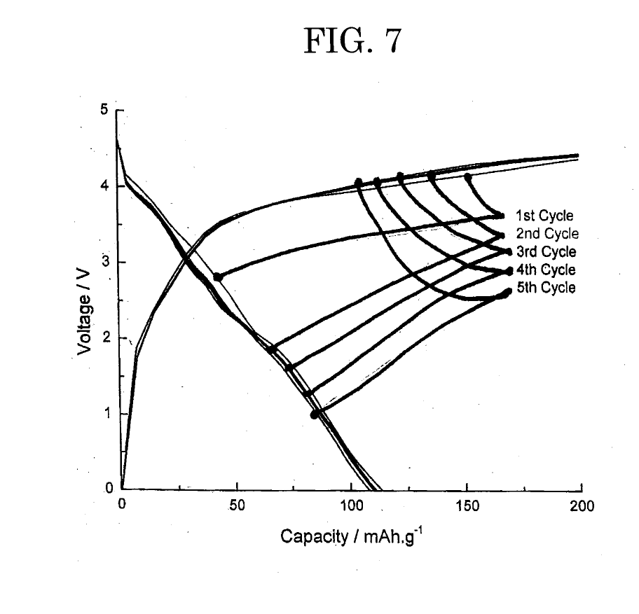

The produced power storage element was subjected to a constant-current charge-discharge test in the same manner as in Example 1. The result is shown in FIG. 7.

From the result of FIG. 7, it can be seen that in the charge curve plotting capacity increase along with voltage rise, a flat portion appeared at or higher than a capacity of 50 mAh/g. Hence, it was revealed that intercalation occurred in the power storage element of Example 6.

### Example 7

### Production of Power Storage Element

A power storage element was produced in the same manner as in Example 1, except that unlike in Example 1, LiBF₄, which was a lithium salt, was added in the non-aqueous electrolytic solution such that the LiBF₄ (Li ion) content would be 50% by mass of the whole electrolyte content.

The produced charge storage element was examined for deposition of a metal Li on the negative electrode. As a result, no remarkable deposition of a metal Li was observed when the lithium salt content was equal to or less than 50% by mass.

From the fact, it was revealed that a suitable lithium salt content of the power storage element of the present invention was equal to or less than 50% by mass of the whole electrolyte content.

### Example 8

### Production of Power Storage Element

A power storage element was produced in the same manner as in Example 1, except that unlike in Example 1, the negative electrode was changed from “E-Gr” in Table 1 to “ANC-Su-2” in Table 1, and a lithium foil (Li foil) was used as the positive electrode. The weight of “ANC-Su-2” was 12.87 mg/cm².

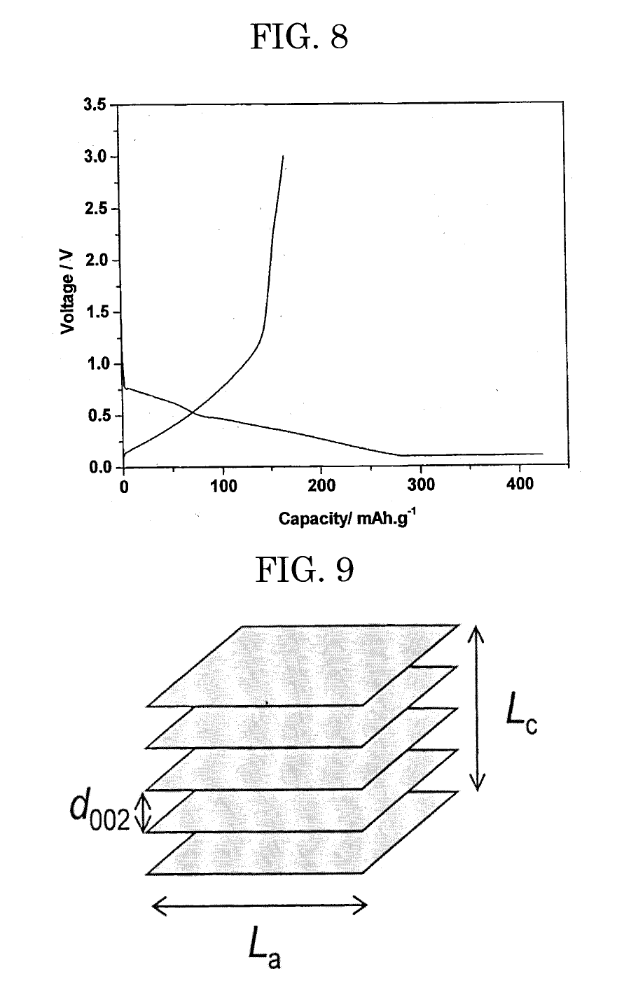

The produced power storage element was subjected to a constant-current charge-discharge test in the same manner as in Example 1. The result is shown in FIG. 8.

From the result of FIG. 8, it was revealed that spirobipyrrolidinium (SBP) ions were intercalated into the negative electrode by charging.

All of the charge storage elements produced in Examples 1 to 8 had a capacity of 10 Wh/kg or higher, which was greater than the capacity of an electric double layer capacitor (from about 0.9 Wh/kg to 7.4 Wh/kg).

Aspects of the present invention are as follows, for example.

<1> A power storage element, including:

a positive electrode;

a negative electrode containing a carbonaceous material as a negative-electrode active material; and

a non-aqueous electrolytic solution obtained by dissolving an electrolyte in a non-aqueous solvent,

wherein a crystallite size Lc₍₀₀₂₎ of the carbonaceous material in a c-axis direction is from 1.65 nm to 241.1 nm, and

wherein cations of electrolyte ions are intercalated into and deintercalated from the negative electrode, and anions thereof are intercalated into and deintercalated from the positive electrode.

<2> The power storage element according to <1>,

wherein the carbonaceous material contained in the negative electrode is an expanded carbonaceous material.

<3> The power storage element according to <1> or <2>,

wherein the cations of the electrolyte ions are at least one kind selected from the group consisting of tetraethyl ammonium (TEA) ions, tetrabutyl ammonium (TBA) ions, and triethylmethyl ammonium (TEMA) ions.

<4> The power storage element according to <1> or <2>,

wherein the cations of the electrolyte ions are pyrrolidinium ions.

<5> The power storage element according to <4>,

wherein the pyrrolidinium ions are ethylmethyl pyrrolidinium (EMP) ions.

<6> The power storage element according to <4>,

wherein the pyrrolidinium ions are spiro-type bipyrrolidinium ions having a two-membered ring.

<7> The power storage element according to any one of <1> to <6>,

wherein the cations of the electrolyte ions are imidazolium derivative ions represented by a general formula 1 below,

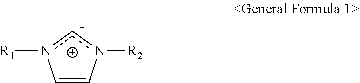

where in the general formula 1 above, R₁ and R₂ may be the same as or different from each other, and are an alkyl group having 1 to 5 carbon atoms.

<8> The power storage element according to any one of <1> to <7>,

wherein the electrolyte in the non-aqueous electrolytic solution contains a lithium salt.

<9> The power storage element according to <8>,

wherein a content of the lithium salt is equal to or less than 50% by mass of a whole electrolyte content.

This application claims priority to Japanese application No. 2014-143974, filed on Jul. 14, 2014 and incorporated herein by reference, and Japanese application No. 2015-085089, filed on Apr. 17, 2015 and incorporated herein by reference.

What is claimed is:

1. A power storage element, comprising:
a positive electrode;
a negative electrode that comprises a carbonaceous material as a negative-electrode active material; and
a non-aqueous electrolytic solution obtained by dissolving an electrolyte in a non-aqueous solvent,
wherein a crystallite size Lc₍₀₀₂₎ of the carbonaceous material in a c-axis direction is from 1.65 nm to 241.1 nm, and
wherein cations of electrolyte ions are intercalated into and deintercalated from the negative electrode, and anions thereof are intercalated into and deintercalated from the positive electrode.

2. The power storage element according to claim 1,
wherein the carbonaceous material comprised in the negative electrode is an expanded carbonaceous material.

3. The power storage element according to claim 1,
wherein the cations of the electrolyte ions are at least one kind selected from the group consisting of tetraethyl ammonium (TEA) ions, tetrabutyl ammonium (TBA) ions, and triethylmethyl ammonium (TEMA) ions.

4. The power storage element according to claim 1,
wherein the cations of the electrolyte ions are pyrrolidinium ions.

5. The power storage element according to claim 4,
wherein the pyrrolidinium ions are ethylmethyl pyrrolidinium (EMP) ions.

6. The power storage element according to claim 4,
wherein the pyrrolidinium ions are spiro-type bipyrrolidinium ions having a two-membered ring.

7. The power storage element according to claim 1,
wherein the cations of the electrolyte ions are imidazolium derivative ions represented by a general formula 1 below, 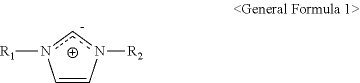
where in the general formula 1 above, R₁ and R₂ may be same as or different from each other, and are an alkyl group having 1 to 5 carbon atoms.

8. The power storage element according to claim 1,
wherein the electrolyte in the non-aqueous electrolytic solution comprises a lithium salt.

9. The power storage element according to claim 8,
wherein a content of the lithium salt is equal to or less than 50% by mass of a whole electrolyte content.
